(19) United States
(12) Patent Application Publication
(10) Pub. No.: US 2016/0203441 A1
(43) Pub. Date: Jul. 14, 2016

(54) Inventory Management and Tracking

(71) Applicant: Landmark Graphics Corporation, Houston, TX (US)

(72) Inventors: William Scott Craig, Houston, TX (US); Timothy Gregg Dew, Houston, TX (US)

(21) Appl. No.: 14/913,512

(22) PCT Filed: Dec. 5, 2013
(86) PCT No.: PCT/US13/73231

§ 371 Date: Feb. 22, 2016

(51) Int. Cl. G06Q 10/08; G06Q 10/10

(52) U.S. Cl. CPC G06Q 10/0875; G06Q 10/103

(57) ABSTRACT

A processor accesses a list of projects, a calendar including a start time when each of the projects is scheduled to begin, and a bill of materials for each of the projects. The bill of materials for each project includes the materials required for that project, wherein some of the materials are common to more than one of the projects. The processor allocates the materials among the projects according to the bill of materials for each project, wherein in allocating the materials the processor gives priority to the projects in order of their start times beginning with the start time nearest in time.

BACKGROUND

Projects to develop the hydrocarbon resources of an oil field often require the drilling of multiple oil wells. Some of the resources needed to support such an effort is dedicated to a particular well. Other resources are moved from well to well according to a well drilling schedule, which is subject to change. Such projects occur in countries around the world. Managing the resources associated with such a project is a challenge.

### BRIEF DESCRIPTION OF THE DRAWINGS

FIG. 1 is a block diagram of a logistics system.

FIG. 2 is a screenshot the forecast dashboard.

FIG. 3 is a screenshot of the executive dashboard.

FIGS. 4A and 4B (pieced together as shown in FIG. 4A) are a screenshot of the well data tab on the material planning tab.

FIGS. 5A, 5B and 5C (pieced together as shown in FIG. 5A) are a screenshot of the material quantity requirements tab of the material planning tab.

FIGS. 6A and 6B (pieced together as shown in FIG. 6A) are a screenshot of the material usage flow tab on the material planning tab.

FIGS. 7A and 7B (pieced together as shown in FIG. 7A) are a screenshot of the quantity required tab on the material planning tab.

FIG. 8 is a block diagram showing an implementation of a “what-if” system.

### DETAILED DESCRIPTION

The description provided herein will focus on coordinated demand planning and inventory management for a large oil field operation. It will be understood that the techniques described herein are applicable to similar projects having dynamic demand and inventory management issues.

As an example of the type of contracts that benefit from the techniques described herein, a contractor has a large well completion contract with a customer to provide completion services for a large number of oil wells the customer is drilling in a country. The contractor is required provide coordinated demand planning and inventory management for the equipment required to fulfill its obligations under the contract. The contractor is providing oil rigs and associated equipment to support the completion service. Providing this service is challenging due to constant changes in the rig schedule, logistical difficulties in country, and poor visibility into the contractor's supply chain.

With regard to demand planning, the systems described herein provide techniques to understand material requirements by well, based on approved well schematics and bills of material (BOMs); to understand material supply by well, including inventory count, on-order count, and shortage and surplus status; to track material status and estimated time of arrival throughout the supply chain; and to provide timely responses to customer requests for material status. With regard to logistics, the systems described herein provide techniques to track shipments, the mode of transport, and the estimated arrival date, to see the status of the import license for each material, and to deal with long and sometimes unpredictable customs delays. With respect to inventory control and management, once inventory is in-country it is stored in a shared yard with inventory belonging to the customer and with other contractors. Such inventory it is conducive to “borrowing and lending,” which can be difficult to track. Inventory may be used, returned, disassembled and re-stocked. These transactions are also difficult to track. Further, the systems described herein provide techniques to track the date on which an asset enters the country because, in some cases, the customer purchases contractor products after being in-country for a period of time. In other situations, a customer buys the contractor equipment the day it enters the country.

The techniques described herein show the inventory position for contractor-owned and customer-owned completion equipment in country. The techniques also allow modeling changes (i.e., “what-if” scenarios) to the well schedule.

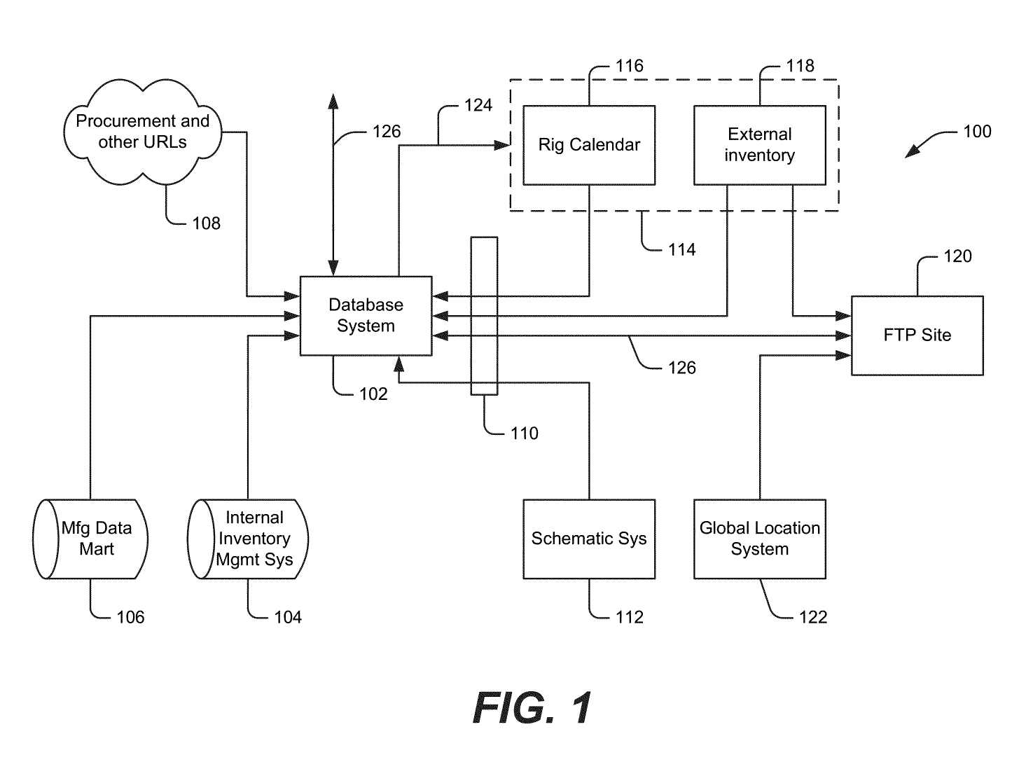

In one embodiment, illustrated in FIG. 1, a system 100 includes a database system 102. In one embodiment, the system 100 is accessed by internal and external users using their email address and password. In one embodiment, the system 100 provides access to customers for the following tabs (described below): a forecast dashboard (or forecast dashboard), a material planning tab, a customer tab (not shown), and a “what if tab” analysis.

In one embodiment, the database system 102 is a QlikView® associative data model system provided by QlikTech International AB Corporation. In one embodiment, the database system 102 extracts (or accesses) inventory data from an internal inventory management system 104, such as SAP®, provided by SAP Aktiengesellschaft Joint Stock Company. In one embodiment, the database system 102 extracts customs data, such as licenses provided by customs brokers and logistics personnel in country, from a manufacturing data mart 106. In one embodiment, the database system 102 extracts data from procurement and other uniform resource locators (“URLs”) 108.

In one embodiment, the database system 102 receives data through a firewall 110. In one embodiment, the database system 102 receives schematics from a schematic system 112 that stores schematics for the wells being drilled. In one embodiment, the database system 102 receives data from customer systems 114. In one embodiment, the database system 102 receives data, such as rig names, dates, and materials, from a customer rig calendar 116. In one embodiment, the database system 102 receives data from an external inventory 118, which includes data, such as inventory material and quantities, about customer inventory in country.

In one embodiment, the database system 102 provides files to a file transfer protocol (“FTP”) site 120 where they can be accessed.

In one embodiment, the FTP site 120 accesses a global location system 122 that provides location information for equipment in the inventory, which in some embodiments is provided by radio frequency identification (“RFID”) tags that are applied to the equipment, shipping container, or crate and tracked by the global location system, such as LoJack®, provided by LoJack Corporation.

In one embodiment, the system 100 integrates with LoJack to GPS track a container in transit.

In one embodiment, the system 100 provides the ability to see all shipments in transit in one screen tab called GPS (not shown) by container number and LoJack number (tracking ID).

In one embodiment, the system 100 provides the ability to view all details related to a container in a summary section located at the top of the GPS tab (not shown) when the user selects the container. In one embodiment, the system 100 displays: container number, tracking ID, value number, purchase order number, shipping document number, a JPEG picture of the container, weight, last known location, pictures of items in the container, and a URL.

In one embodiment, the system 100 provides the ability to view the current location (by coordinates or by address) by navigating to the URL previously provided in the summary section of the GPS tab (not shown).

In one embodiment, the system 100 provides the ability to view details related to a container in an item detail section located at the bottom of the GPS tab (not shown) when the user selects the container. The information displayed includes the material number, the material quantity, the material description, the value, and the purchase order.

In one embodiment, the system 100 provides the ability to see a map on the LoJack website with a picture of all containers in transit.

In one embodiment, the system 100 provides the ability to locate items via radio frequency identification (“RFID”) beacon. In one embodiment the tracking is done by way of a radio frequency (“RF”) beacon using a handheld device to find a container once it is in the destination country. In one embodiment, the RF beacon is placed on the equipment at manufacturing time to enable the RFID tracking at the receiving location.

In one embodiment, the system 100 generates an email once a shipment has departed from the original country.

In one embodiment, the system 100 generates an email/alert notification once a shipment has left +/1 day from arrival in country.

In one embodiment, the database system 102 provides e-mail notifications 124 to the customer. In one embodiment, the database system 102 provides a user interface represented by arrow 126, through which the database system 102 can be updated and queried. In one embodiment, queries to the database system 102 include “what-if” scenarios. In one embodiment, the “what-if” scenarios are provided in the form of revised rig calendars from the customer's rig calendar system 116. In one embodiment, the results 126 of the “what-if” scenarios are provided to the FTP site 120 where they can be accessed.

### Forecast Dashboard

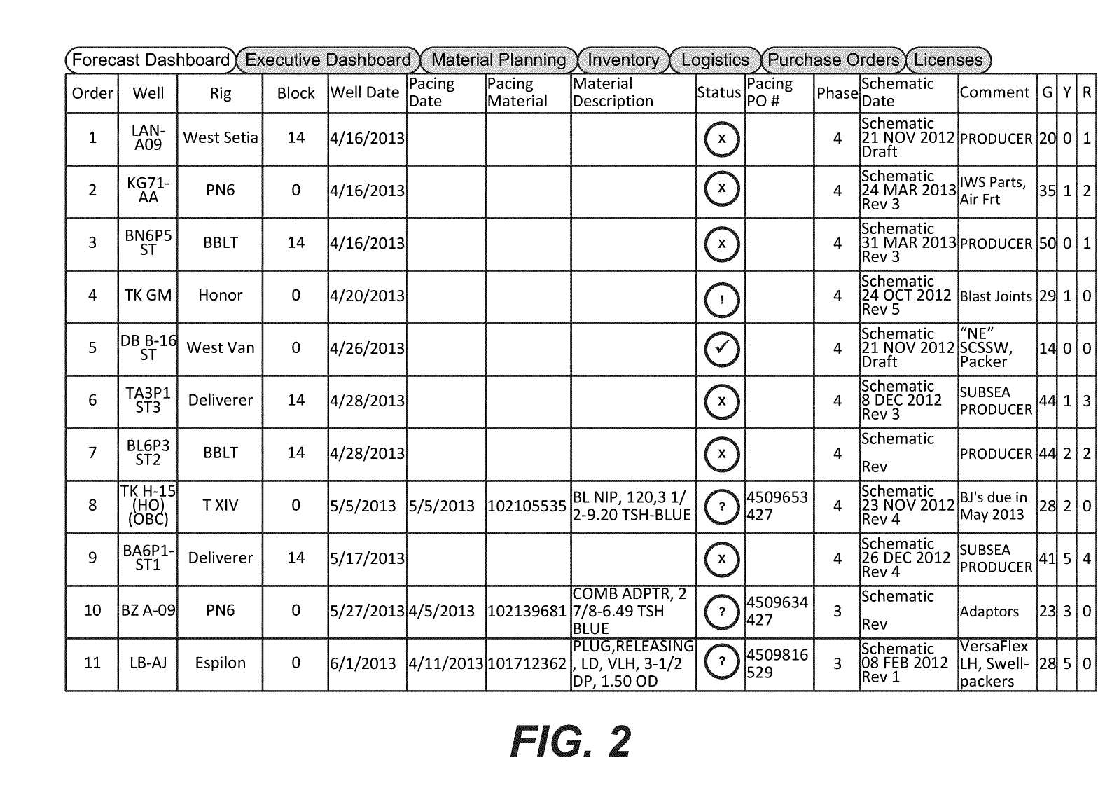

In one embodiment, the user interface 126 provides a forecast dashboard (or “forecast tab”), illustrated in FIG. 2. In one embodiment, the forecast dashboard includes an “order” column, which reflects the order that the wells are to be drilled. In one embodiment, the forecast dashboard includes a “well” column that includes the name of the well to be drilled. In embodiment, the forecast dashboard includes a “rig” column that provides the name of the rig that will be used to drill the well. For example, the first well to be drilled is the LAN-A09 well to be drilled with the West Setia rig.

In one embodiment, the forecast dashboard includes a “block” column that provides a geographical block designator for the well to be drilled (e.g., “14” for the first well to be drilled). In one embodiment, the forecast dashboard includes a “well date” column that provides the planned drilling date for the well (e.g. “Apr. 16, 2013” for the first well to be drilled).

In one embodiment, the forecast dashboard includes a “pacing date” column that includes the date that material deemed to be the pacing item (i.e., the longest lead item) on the BOM that will complete the well order material requirement. For example, the pacing date for the eighth well on the list is May 5, 2013. In one embodiment, the pacing date is accessed from the inventory management system 104.

In one embodiment, the forecast dashboard includes a “pacing material” column that provides a designator for the material that is pacing the designated well. For example, the pacing material for the eighth well in the list is “102105535.”

In one embodiment, the forecast dashboard includes a “material description” column that includes a description of the pacing material for that well. For example the material description for the pacing material for the eighth well in the list is “BL NIP, 120,3 1/2-9.20 TSH-BLUE.”

In one embodiment, the forecast dashboard includes a “status” column that provides a graphical indication of the status of the well. In one embodiment, the “status” column provides four possible graphical indicators for material status for the well associated with the corresponding row. In one embodiment, the graphical indicators provide information through color and symbols. In one embodiment, a red graphical indicator with an “X” (see, e.g., rows 1, 2, 3, 6, 7, and 9) indicates that materials are not in stock for the job, that they are not on order, and that the lead time for ordering parts is nine months. In one embodiment, a green graphical indicator with a check (“✓”) (see the status for well order 5) indicates that materials are in stock for the job. In one embodiment, a yellow graphical indicator with a “?” (see the status for well orders 8, 10, and 11) indicates that the equipment has been ordered on a purchase order and is somewhere between manufacturing and goods receipt. In one embodiment, a yellow graphical indicator with a “!” (see the status for well order 3) indicates that the equipment has been ordered, but without a purchase order, and is somewhere between manufacturing and goods receipt. This color scheme (red for trouble, yellow for possible trouble, and green for “all is well”) is used as visual cues on other system screens, as discussed elsewhere in this application.

In one embodiment, the forecast dashboard includes a “pacing PO #” column that provides the purchase order number for the pacing material. For example, the purchase order for the pacing material for the eighth well in the list is “4509653427.”

In one embodiment, the forecast dashboard includes a “phase” column that provides the phase of the well represented by that row. In one embodiment, the possible phases are development (1), planning (2), approval (3), and ready for production (4). For example, the phase of the eighth well in the list is “4” meaning that it is ready for production.

In one embodiment, the forecast dashboard includes a “schematic date” column that provides information about the schematic for the well associated with that row. For example, as regards the eighth well in the list, the schematic being used is dated Nov. 23, 2012 and is in its fourth revision. In one embodiment, entries in this column include a link to the latest well schematic revision.

In one embodiment, the forecast dashboard includes a “comment” column that provides a place to store comments about the well associated with that row. For example, as regards the eighth well in the list, the comment “BJ's due in May 2013” (“BJ's are Blast Joints) is recorded.

In one embodiment, the forecast dashboard includes three columns, labeled respectively “G” (for green), “Y” (for yellow), and “R” (for red), which record the number of material items having green, yellow, or red statuses. For example, the second well in the list, which has a “red X” in the status column (indicating, as described above, that materials are not in stock for the job, that they are not on in order, and that the lead time for during parts is nine months), shows 35 items in the G column, 1 item in the yellow column, and 2 in the red column. This indicates that of the materials needed for the well, 35 are in stock (the G column), 1 is not in stock but is on order (the Y column), and 2 are not in stock, are not on order, and the lead time for ordering parts is nine months (the R column).

In one embodiment, a user of the forecast dashboard has the ability to flag a well as complete.

In one embodiment, the contractor and the customer can propose well changes on the forecast dashboard by changing the well date.

In one embodiment, proposed schedule modifications are received. In one embodiment, proposed schedule modifications are received via Excel spreadsheets.

In one embodiment, the well schedule can be modified systemically and new sequencing can be viewed.

In one embodiment, the status of the well and the well date can be changed. The following fields are used for calculations and logic: estimated completion date of the manufacture for the materials needed, adding average time for shipment, and adding average time for customs.

In one embodiment, the contractor and the customer can view proposed well changes and the revised proposed well schedule. In one embodiment, well schedule changes can be made until the last day.

In one embodiment, the contractor and the customer can see a summary of all well schedule changes. In one embodiment, the system displays a change history log of all well changes (approval) in a separate tab (not shown) called change log.

In one embodiment, the customer has the ability to distribute the proposed well change by email. In one embodiment, the email contains well schedule changes and schematic revisions.

In one embodiment, the well change email prompts the recipient to login to the system to view the updated dashboard.

In one embodiment, the customer has the ability to co-approve a well change schedule. In one embodiment, the contractor cannot approve or reject the proposed well changes by the customer.

In one embodiment, the scheduling change must be approved by at least one customer-approved approver.

In one embodiment, the customer has the ability to reject proposed well changes.

In one embodiment, an approver (such as a customer) can submit and view the latest status of approved changes and notifications.

In one embodiment, the forecast dashboard displays approved well changes, including details such as the name of the approver and time stamps.

In one embodiment, the well schedule is displayed until it is complete. In one embodiment well schedule completion is determined by tracking fulfillment status (by material) for a well's sales order. In one embodiment, upon completion, the well is no longer incorporated into the schedule. In one embodiment, contractor personnel logon to the system to mark the well as complete after running the material.

In one embodiment, the system 100 confirms or pegs open demand with available/projected supply based on well priority.

In one embodiment, the system 100 provides the ability to initiate a well as a forecasted bill of materials, linking to a well ID.

In one embodiment, the system 100 searches the internal inventory management system 104 to fill demand before manufacturing.

In one embodiment, the system 100 fulfills projected demand with available inventory customer inventory before fulfilling with contractor inventory.

In one embodiment, the system 100 provides the ability to flag an item number from an earlier inventory to an item list. In one embodiment, the system 100 provides the ability to export available inventory (quantity and location) in other field plants from the internal inventory management system 104.

In one embodiment, the system 100 provides the ability to consider availability in other plants prior to recommending that a purchase order be placed.

In one embodiment, the system 100 integrates with the internal inventory management system 104. In one embodiment, the system performs materials requirements planning that nets out inventory available and places orders for future requirements. In one embodiment, the system provides the ability for the contractor to pass the customer if the customer is sure that it wants to have ordered equipment manufactured before manufacturing actually begins.

In one embodiment, the system 100 provides the ability to calculate recommended order (purchase order) quantity accounting for target and safety stock levels (based upon utilization).

In one embodiment, the system 100 provides an intelligent ordering capability that identifies fast moving “standard” items. In one embodiment, the system 100 provides the ability to consider opportunities for reorder points (ROP) and reorder quantity-ability (ROQ) to segment/classify items based on demand volume and frequency of use. In one embodiment, the data for this assessment is sourced from the internal inventory management system 104.

In one embodiment, the system 100 has the ability to regenerate material shortage, late purchase order, manufacturing miss, well data adherence, etc., notifications automatically after modifying the well schedule.

In one embodiment, the system 100 distributes updated forecast dashboards to external and internal users only when there is a well schedule change or equipment status. This is to prevent flooding users with unnecessary updates. In one embodiment, the system allows the users to select a predefined distribution list based on which rig schedule has been updated.

### Executive Dashboard

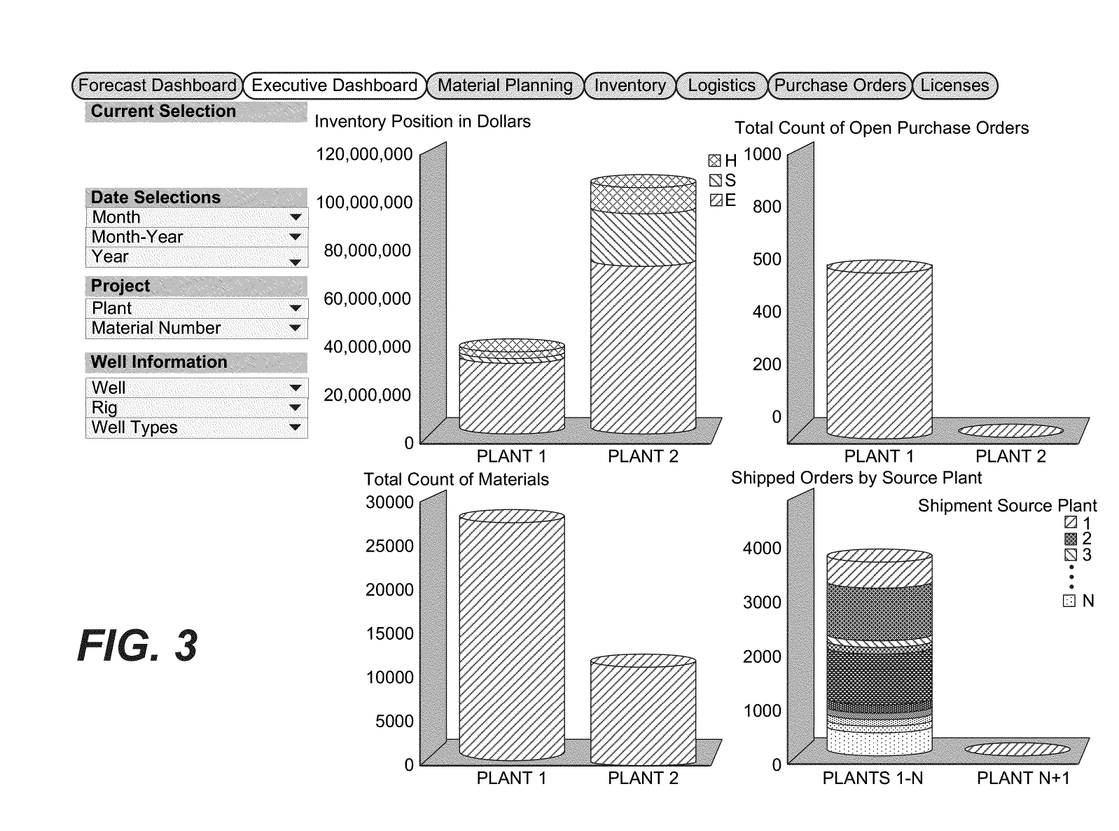

In one embodiment, the user interface 126 provides an executive dashboard (or “executive tab”), illustrated in FIG. 3, which provides a high level overview for managers to determine inventory position in dollars (the upper left graph), open purchase orders (the upper right graph), total count of materials (the lower left graph), and shipped orders by source plants (the lower right graph), and other similar information.

In one embodiment, the executive dashboard displays revenue, cost, and profit for the current month, the current quarter, and the current year over 212 historical months and 18 forecasted months at the field location and well levels. Selections are made using the drop-down menus on the left side of the screen (“Date Selections,” “Project,” and “Well Information”). In one embodiment, historical numbers contain both forecasted and actual numbers.

In one embodiment, the executive dashboard displays the above-referenced financial information in a sub tab entitled “Financials” (not shown). In one embodiment, the executive dashboard includes inventory and logistics/orders sub tabs (not shown).

In one embodiment, revenue and forecasted revenue are derived from the contractor's selling price to the customer. In one embodiment, this information comes from the contractor/customer contract. In one embodiment profit is a calculated value that is the difference between revenue (selling price) and internal cost (cost of goods sold). In one embodiment, cost is defined as the contractor's cost of goods sold.

In one embodiment, the executive dashboard provides a table in the financials sub tab (not shown) that aligns with the revenue/profits/cost chart described above and contains the following fields: month, region, customer, well, forecasted revenue, actual revenue, cost, forecasted profit, and actual profit.

In one embodiment, the financials sub tab (not shown) on the executive dashboard, displays revenue (historical and forecast) year-to-date against goals for the current fiscal year at the field location level.

In one embodiment, the financials sub tab (not shown) on the executive dashboard displays a table that aligns with the revenue year-to-date chart described above and contains the following fields: month, region, customer, last year actual, current year goal, current year actual, current year forecast, cumulative delta (for actual), and cumulative delta (for forecast).

In one embodiment, the executive dashboard includes a logistics/orders sub tab (not shown) that provides two stacked barcharts showing the value and count of air freight orders, or ocean freight, trending over time (historical 24 months) including the following information: total, air, ocean, and truck. In one embodiment, the first chart that displays time versus dollar value. In one embodiment, the second chart displays time versus count.

In one embodiment, the two stacked barcharts on the logistics/borders sub tab (not shown) have the following headers: month, method of shipment, cost/value, and number of materials.

In one embodiment, a logistics sub tab (not shown) on the executive dashboard provides stacked barcharts showing the current value and count of material by stage and by need-date month. In one embodiment the stages are: “on order,” “in manufacturing,” “in transit,” and “in customs”. In one embodiment, the chart allows a user to see the count of material when a mouse pointer is hovered over the stacked bars. In one embodiment, the date range is six months historical and 18 months forecast.

In one embodiment, the logistics/orders sub tab (not shown) on the executive dashboard includes the data of the above described chart in a table with the following headers (by purchase order): need-by date, quantity in customs, quantity in transit, quantity in manufacturing, quantity on order, value in customs, value in transit, value in manufacturing, and value on order.

In one embodiment, the executive dashboard includes an inventory sub tab (not shown) that shows the current value and count of material by location. In one embodiment, this information is provided in the upper left-hand chart and the lower left-hand chart shown in FIG. 3. In one embodiment, “location” is defined as a plant (i.e., a manufacturing plant). In other embodiments, “location” is defined as one of the following: ordering plant, selling plant, customer storage locations, Expro and point. In one embodiment, the display includes the material in backup status located in an equipment quantity required tab (not shown) in a separate bar chart (not shown). In one embodiment, the value of the part number is displayed when the mouse pointer is hovered over the material. In one embodiment, “value” is defined as the contractor's selling price. In one embodiment, a first chart contains location versus dollar value (see the upper left chart in FIG. 3). In one embodiment, a chart displays location versus count (see the lower left chart in FIG. 3).

In one embodiment, the inventory sub tab (not shown) on the executive dashboard provides the above data in a table with the following headers: field location, inventory (plant) location, material number, material description, quantity, and value.

In one embodiment, the inventory sub tab (not shown) on the executive dashboard provides two bar charts showing the current value and count of material by availability status. The statuses are: healthy (0 to 6 months), slow moving (6-12 months), and excess and obsolete (12+ months). An example of such a bar chart is provided in the upper left chart in FIG. 3. In the key shown in the upper right of the chart, “healthy” is abbreviated “H”, “slow moving” is abbreviated “S”, and “excess and obsolete” is abbreviated “E.”

In one embodiment, the inventory sub tab (not shown) on the executive dashboard includes a table with the data from the above charts. In one embodiment, the table includes the following headers: field location, material number, material description, total quantity in inventory, cost price (unit price), total value in inventory, healthy count, healthy value, slow count, slow value, excess count, excess value, obsolete count, and obsolete value.

In one embodiment, the inventory sub tab (not shown) on the executive dashboard includes a single line chart showing the historical annual inventory “turns” over 24 months. In one embodiment, it is at a total level. In one embodiment “turns” is defined to be annual usage divided by current inventory.

In one embodiment, the inventory sub tab (not shown) on the executive dashboard provides the data of the above charts in a table with the following headers: month, field location, inventory, usage, turns, and turns (goal).

In one embodiment, the “shipped orders by source plant” chart at the lower right in FIG. 3 displays source plants on the horizontal axis and shipped orders on the vertical axis, with the layers in the cylinders representing the different plants. A key in the upper right of the chart identifies the different plants. The plant identifications in FIG. 3 are abbreviated to numbers for simplicity of presentation.

In one embodiment, the “shipped orders by source plant” chart displays source plants by country and to list the plant number with plant name and contains data only for open purchase orders. In one embodiment, the “shipped orders by source plant” chart is on the logistics sub tab (not shown) on the executive dashboard.

In one embodiment, the logistics sub tab (not shown) on the executive dashboard includes a table with the above data. The table has the following headers: plant number, plant name, purchase order number, country, quantity, and value.

In one embodiment, each of the charts on the executive dashboard includes a table below the chart (not shown) that displays the relevant data in table format respective to each chart such that the changes made to the chart are also reflected in the table below it.

In one embodiment, the user is allowed to specify a time horizon and/or a time bucket (i.e., monthly, quarterly, annually) for all charts shown on the executive dashboard.

In one embodiment, a chart and its associated table can be printed together.

In one embodiment, the executive dashboard and the customer dashboard (not shown), in a sub tab named Inventory Aging Report (not shown), provides an aging report that shows the equipment's inventory age, which is tracked using “goods received date”. In one embodiment, the aging report shows inventory value total by age (e.g., $5M in inventory; 3M of the 5M is over 60 days old; 2M of the 5M is under 60 days old). In one embodiment, the aging report provides the ability to drill down by item class and material. In one embodiment, the aging report provides the ability to display aging at monthly intervals up to 24 months or beyond. In one embodiment the aging report only applies to contractor-owned equipment.

In one embodiment, the system provides the ability to select the date range of the buyback feature.

In one embodiment, the system has the ability to import the backup quantity and customer owned inventory numbers from an Excel file via the database system 102 and display data in the material planning well data sub tab.

### Logistics Tab (Not Shown)

In one embodiment, a logistics tab provides the ability to track a purchase order from manufacturing source plant to field plant and from one field plant to another field plant (not shown).

### Purchase Orders Tab (Not Shown)

In one embodiment, a purchase order dashboard places a manufacturing actual start date after a customer destination name (Not Shown).

In one embodiment, a manufacturing forecasted completion date is inserted between a customer destination name and a departure source plant column in the purchase orders dashboard (not shown).

### Customer Dashboard (Not Shown)

In one embodiment, the user interface 126 provides a tab called customer dashboard that is accessible to the contractor and to the customer.

In one embodiment, the customer dashboard contains charts relating to the customer data. In particular, the customer dashboard contains charts relating to: inventory turn, inventory value by location, inventory quantity by location, inventory value by availability, inventory quantity by availability, and usage ($) by month.

In one embodiment, the customer dashboard provides a chart showing all customer inventory.

In one embodiment, the customer dashboard provides a single line chart showing the historical annual inventory turns over 12 months. In one embodiment the chart is at the total level.

In one embodiment, the customer dashboard provides the data from the above charts in a table with the following headers: month, field location, inventory, usage, turns, and turns (goal).

In one embodiment, the customer dashboard provides two bar charts showing the current value and count of material by availability status. In one embodiment, the possible statuses are as described above.

In one embodiment, the customer dashboard provides the data of the charts described above in a table with the following headers: field location, material number, material description, total quantity in inventory, cost price (unit price), total value in inventory, healthy count, healthy value, slow count, slow value, excess value and obsolete count, excess count and obsolete value.

In one embodiment, the customer dashboard includes an Inventory sub tab that shows the current value and count of material by location. In one embodiment, the first chart displays location versus dollar value. In one embodiment, the second chart displays location versus count.

In one embodiment, the inventory sub tab (not shown) on the customer dashboard provides the data of the above charts in a table with the following headers: field location, inventory (plant) location, material number, material description, quantity, and value.

In one embodiment, the customer dashboard provides a bar chart showing actual, outstanding (materials not issued by due date) and forecasted material usage dollars for the fiscal year (year-to-date) by month.

In one embodiment, the customer dashboard provides the data of the above charts in a table with the following headers: month, field location, actual usage (year-to-date), outstanding usage, and forecasted usage.

### Notifications Tab (Not Shown)

In one embodiment, the user interface 126 provides a notifications tab that contains four notification types: inventory deficit (unmet demand), inventory deficit (below safety stock), manufacturing delay, and surplus order.

In one embodiment, the data fields for the inventory deficit (unmet demand) notification are: notification type—unfilled demand, need-by date, material number, quantity deficit, and comments/reason.

In one embodiment, the data fields for the inventory deficit (below safety stock) notification type are: notification type—safety stock, need-by date, material number, quantity deficit, and comments/reason.

In one embodiment, the data fields for the manufacturing delay notification type are: material number, sales order number, original date, revised date, plant source, and comments/reason.

In one embodiment, the data fields for the surplus order notification type are: item, month, quantity, need date, and comments/reason. In one embodiment, the notification includes the following text “You already have excess inventory for this part number. Are you sure you want to order more?”

In one embodiment, the system 100 sends an e-mail to a contractor representative and to a customer representative of a surplus order notification. In one embodiment, the notification includes the following text: “You already have excess inventory for this part number. Are you sure you want to order more?”

In one embodiment, the system sends a notification email to a contractor representative and a customer representative of a well schedule update available for view on the dashboard and provides a shot snapshot of the forecast dashboard in the email.

In one embodiment, the system provides an email notification of an inventory deficit (late equipment), when material is on order but estimated to arrive late (resulting in schedule impact/delay).

In one embodiment, the system issues an email when an order is delayed in manufacturing. In one embodiment, the notification issues directly from the internal inventory management system 104.

In one embodiment, a link to a “procurement, materials and logistics” process is provided on the notifications tab.

In one embodiment, the system provides a link to advanced material search on the notifications tab.

### Material Planning Tab

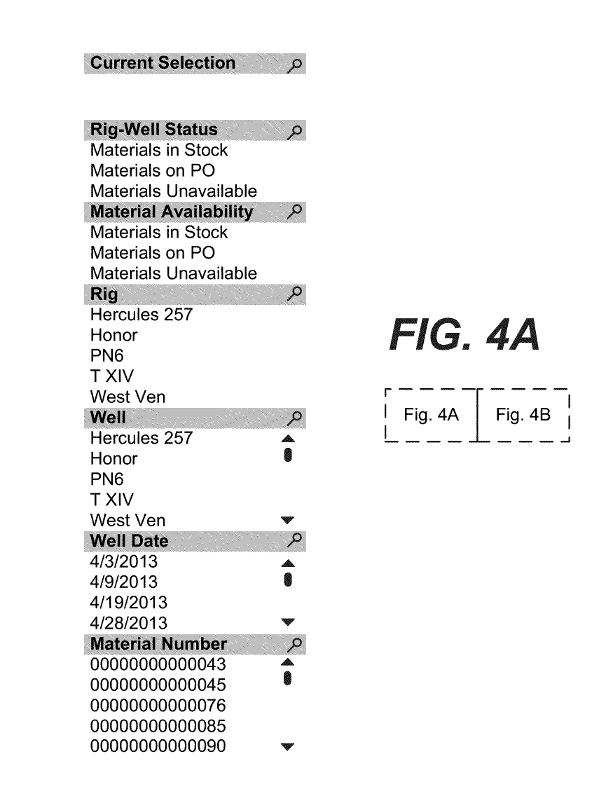

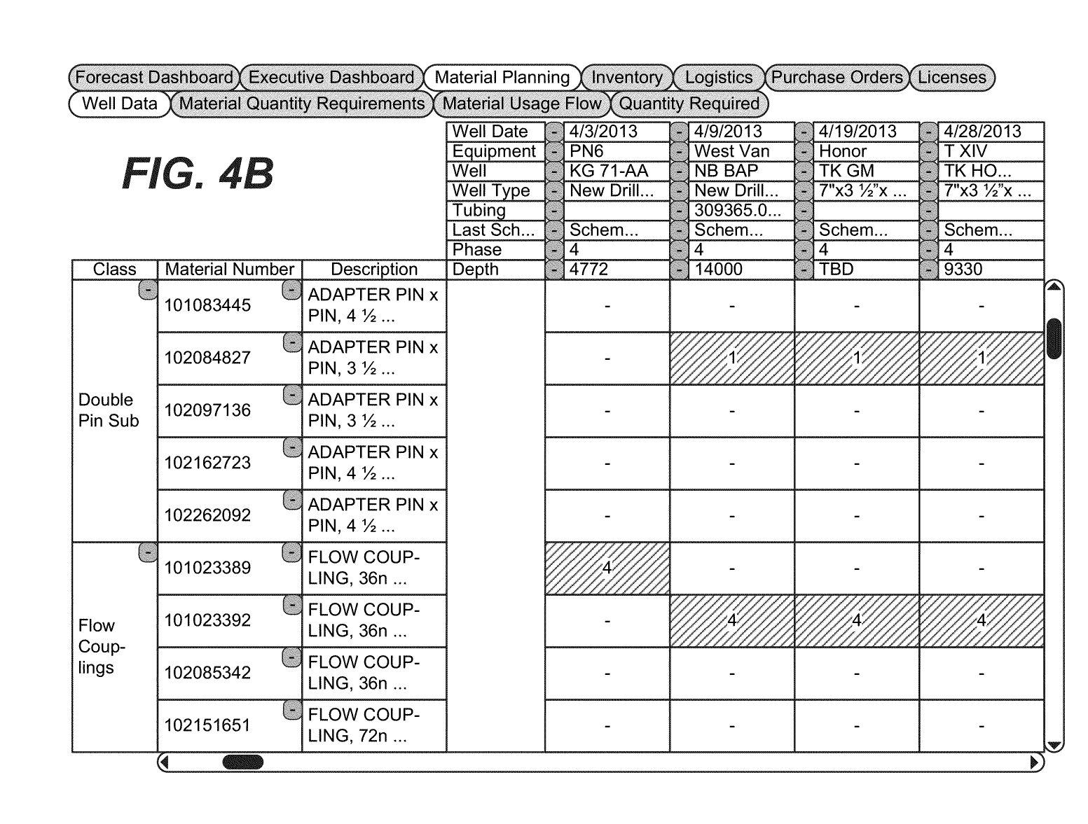

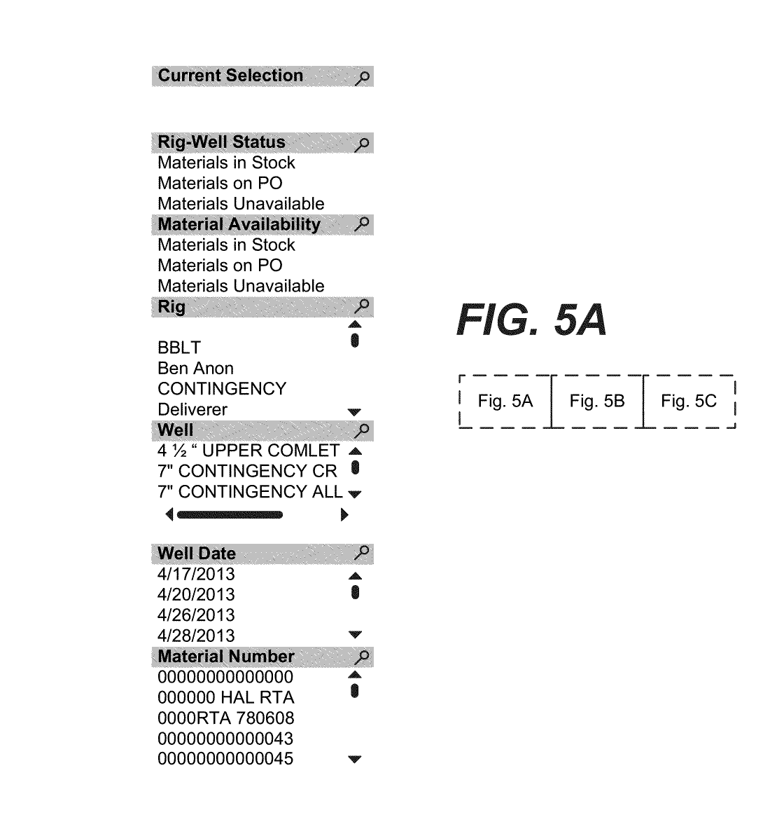

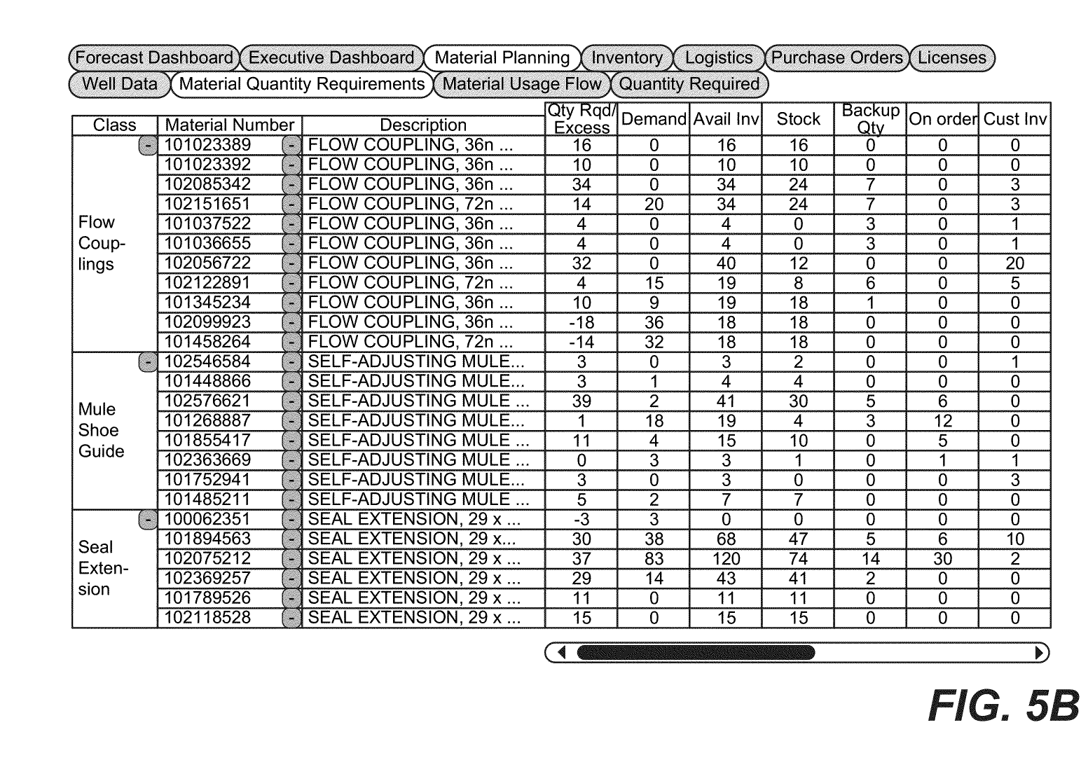

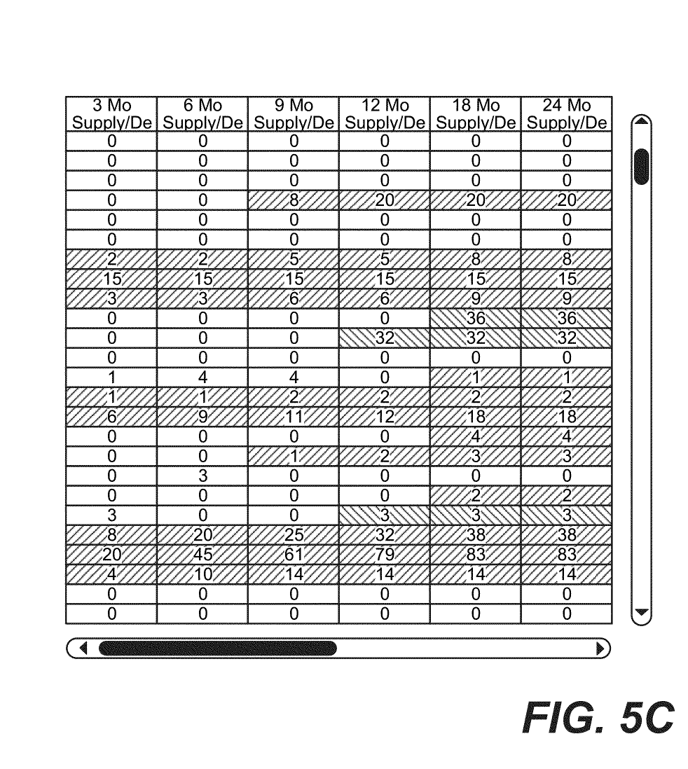

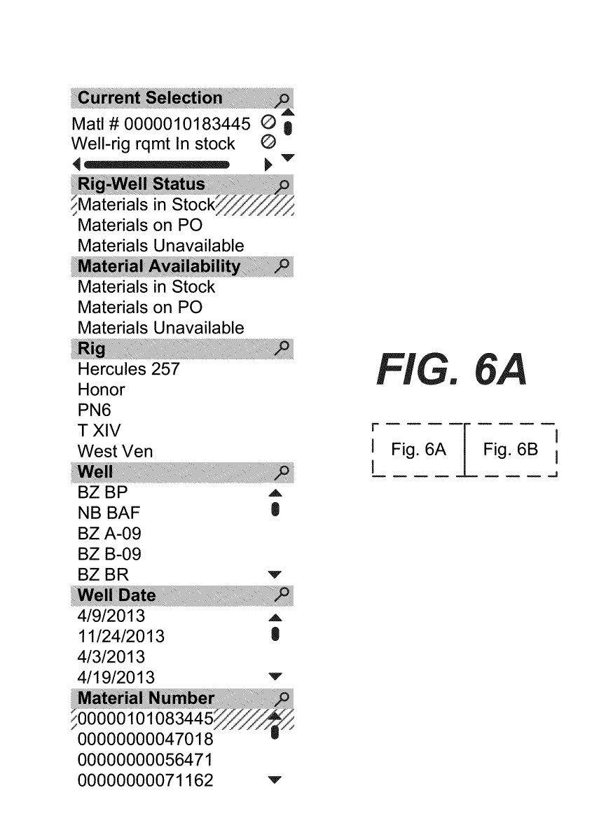

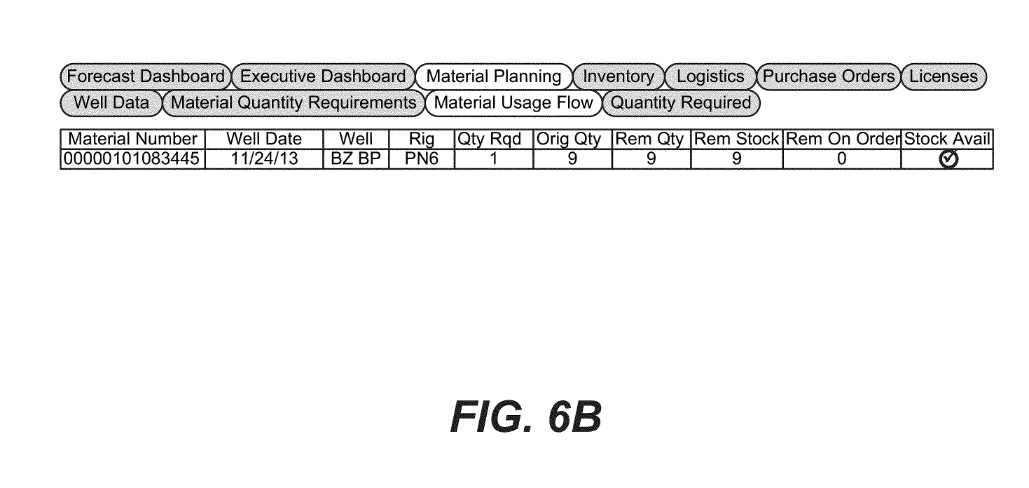

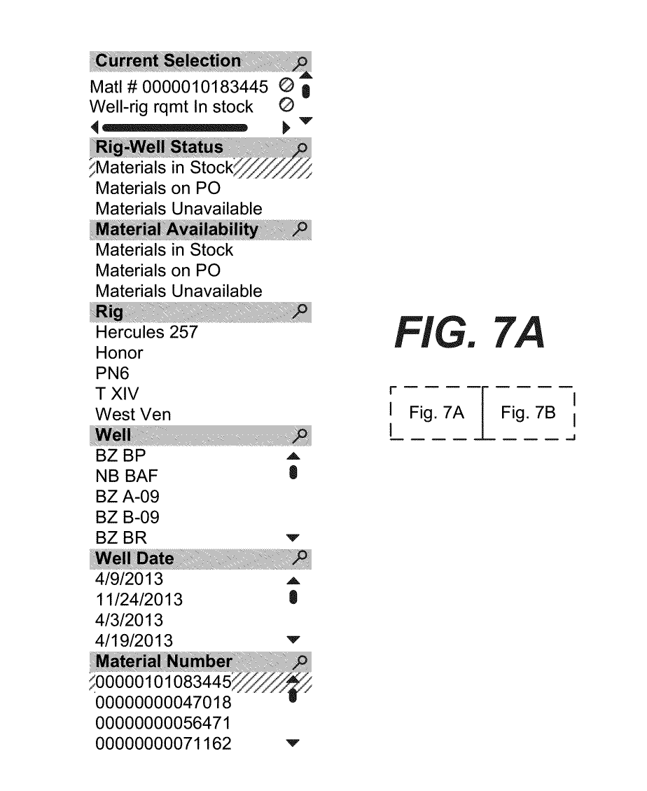

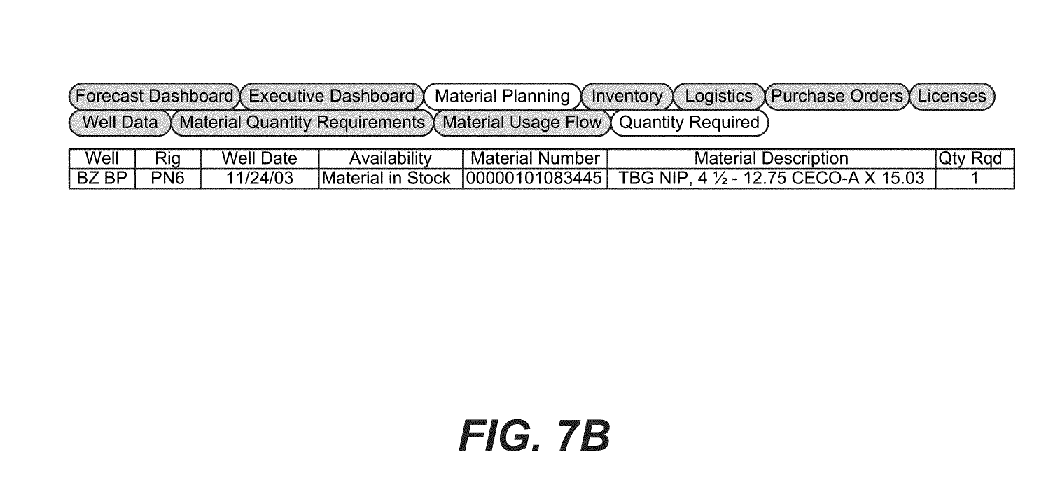

In one embodiment, the user interface 126 provides a material planning tab, illustrated in FIGS. 4A-4B, 5A-5C, 6A-6C, and 7A-7B. The material planning tab includes four sections: the well data section (FIGS. 4A-4B), the material quantity requirements section (FIGS. 5A-5C), the material usage flow section (FIGS. 6A-6C), and the quantity required section (FIGS. 7A-7B).

In one embodiment, the material planning tab provides a report on manufacturing time and delivery time, which are based on lead time statements from manufacturers. In one embodiment, the material planning tab provides a report showing a list of all part numbers with manufacturing time from different source plants.

In one embodiment, lead time can be different for different source plants.

### Material Planning Tab—Well Data Section

In one embodiment, the well data section, illustrated in FIGS. 4A and 4B, illustrates the well schedule with the material requirements for each well.

In one embodiment, the well data section includes a selection panel, illustrated in FIG. 4A. In one embodiment, a user can select the data to display on the well data section using the selection panel. In one embodiment, the selection panel includes a “Current Selection” area that displays the current selection criteria. In one embodiment, the selection panel includes a “Rig—Well Status” area that allows selection of materials in stock, materials on purchase order, or materials unavailable. In one embodiment, the selection panel includes a “Material Availability” area that allows the selection of materials in stock, materials on purchase order, or materials unavailable. In one embodiment, the selection panel includes a “Rig” area that allows selection of one of the rigs included in the data (in the example shown, the rigs are Hercules 257, Honor, PN6, T XIV, and West Ven, with a scroll bar indicating that additional rigs are available for selection). In one embodiment, the selection panel includes a “Well Date” area that allows selection of one of the displayed well dates (in the example shown, the well dates are Apr. 3, 2013, Apr. 9, 2013, Apr. 19, 2013, and Apr. 28, 2013, with a scroll bar indicating that additional well dates are available for selection). In one embodiment, the selection panel includes A “material number” area that allows selection of one of the displayed material numbers (in the example shown, the material numbers are 00000000000043, 00000000000045, 00000000000076, 00000000000085, and 00000000000090 with a scroll bar indicating that additional material numbers are available for selection).

In one embodiment, the well data section includes a data presentation area, illustrated in FIG. 4B. In one embodiment, the data presentation area organizes data by material on a vertical axis and by wells on a horizontal axis. In one embodiment, the vertical axis includes a “class” column, which describes a class of materials (e.g., “Double Pin Sub” and “Flow Coupling”), a “material number” column, which lists the material numbers that belong to the corresponding class (e.g. Material number 101083445 belongs to the class “Double Pin Sub”) and a “description” column, which provides a description of the corresponding material number (e.g. Material number 101083445 is described as an

“ADAPTER PIN, 4½ . . . ”). In one embodiment, a scroll bar indicates that additional material classes are available for viewing.

In one embodiment, the horizontal axis lists the wells in well data order from earliest to latest. In one embodiment, in addition to listing the well date, the equipment, well, well type, two being, last schematic, and phase are also listed. For example, for well data Apr. 3, 2013 the equipment is P and six the well is KG 71-AA, the well type is a new drilling, the tubing is not specified, the last schematic cannot be seen in this presentation (although it can be seen by hovering the mouse cursor over the field), the phase is four, and the depth is 4772. In one embodiment, a scroll bar indicates that additional wells are available for viewing.

In one embodiment, a grid appears to the right of the vertical axis and below the horizontal axis. In one embodiment, the grid specifies whether the material in the vertical axis is required for the well in the horizontal axis. For example, the dash in the Apr. 3, 2013 well column and the material number 101083445 row indicates that double pin sub 101083445 is not necessary for the Apr. 3, 2013 well. The “4” in the Apr. 3, 2013 12 column and the material number 101023389 row indicates that 4 flow couplings 101023389 are needed for the Apr. 3, 2013 well.

In addition to the numerical information provided in the grid, the cells in the grid are color coded (represented by the crosshatching in the cells containing numbers) to indicate their procurement status. In one embodiment, the color coding is the same as that described above with respect to the forecast dashboard. In one embodiment, green shading (represented by the lower left to upper right crosshatching) indicates that the materials are in stock, yellow shading (none of the cells in FIG. 5C have this status) indicates that materials are on order but not in stock, and red shading (none of the cells in FIG. 5C have this status) indicates that materials are not in stock, are not on order and that the lead time for ordering parts is nine months.

### Material Planning Tab—Material Quantity Requirements Section

In one embodiment, the material quantity requirements section, illustrated in FIGS. 5A-5C, provides the required quantities by material and the state including showing the excesses and shortages by quarter.

In one embodiment, the material quantity requirements section of the material planning tab (see FIG. 5B) displays a column that identifies and tracks “backup equipment.” In one embodiment, this column identifies the backup equipment that is on order.

In one embodiment, the material quantity requirements section of the material planning tab (see FIG. 5A) provides a search capability on the attribute Part Number—Legacy#. In one embodiment (not shown), the Legacy# information is displayed after the material number column and before the description column. In one embodiment, the Legacy# number is delivered when the schematic is pushed out to FTP site for the database system 102.

In one embodiment, the material quantity requirements section includes a selection panel, illustrated in FIG. 5A. In one embodiment, a user can select the data to display on the material quantity requirements section using the selection panel. In one embodiment, the selection panel includes a “Current Selection” area that displays the current selection criteria. In one embodiment, the selection panel includes a “Rig—Well Status” area that allows selection of materials in stock, materials on purchase order, or materials unavailable. In one embodiment, the selection panel includes a “Material Availability” area that allows the selection of materials in stock, materials on purchase order, or materials unavailable. In one embodiment, the selection panel includes a “Rig” area that allows selection of one of the rigs included in the data (in the example shown, the rigs are BBLT, Ben Anon, CONTIGENCY, and Deliverer, with a scroll bar indicating that additional rigs are available for selection). In one embodiment, the selection panel includes a “Well” area that allows selection of one of the wells included in the data (in the example shown, the wells are 4½″ UPPER COMLET, 7″ CONTINGENCY CR, and 7″ CONTINGENCY ALL, with a horizontal scroll bar indicating that the well names are not entirely displayed and a vertical scroll bar indicating that additional Wells are available for selection). In one embodiment, the selection panel includes a “Well Date” area that allows selection of one of the displayed well dates (in the example shown, the well dates are Apr. 17, 2013, Apr. 20, 2013, Apr. 26, 2013, and Apr. 28, 2013, with a scroll bar indicating that additional well dates are available for selection). In one embodiment, the selection panel includes A “material number” area that allows selection of one of the displayed material numbers (in the example shown, the material numbers are 00000000000000, 0000000 HAL RTA, 0000RTA 780608, 00000000000043, and 00000000000045 with a scroll bar indicating that additional material numbers are available for selection).

In one embodiment, the material quantity requirements section includes a data presentation area, as illustrated in FIGS. 5B and 5C. In one embodiment, the data presentation area organizes dated by material on the vertical axis and by requirements for those materials on the horizontal axis. In one embodiment, the horizontal axis is similar to that described above in the description of FIG. 4B, in which the well data section data presentation area was described.

In one embodiment, the horizontal axis includes a quantity required/excess (“Qty Rqd/Excess”) column that discloses the quantity of the corresponding material number that is in excess or in shortage. For example, material number 101023389 has an excess of 16 parts. In contrast, material number 101458264 has a shortage of 14.

In one embodiment, the horizontal axis includes a demand column that discloses the quantity of the corresponding material number that is needed for the job. For example, material number 101023389 has a demand of 0. Material number 101458264 has a demand of 32.

In one embodiment, the horizontal axis includes an available inventory (“Avail Inv.”) column that discloses the quantity of the corresponding material number that is in available inventory (i.e. in stock, in backup, on order, or in the customer's inventory). For example, material number 101023389 has an available inventory of 16. Material number 101458264 has an available inventory of 18.

In one embodiment, the horizontal axis includes a stock column that discloses the quantity of the corresponding material number that is in stock. For example, material number 101023389 has a stock of 16. Material number 101458264 has a stock of 18.

In one embodiment, the horizontal axis includes a backup quantity (“Back Qty”) column that discloses the quantity of the corresponding material number that is in backup stock. For example, material number 101023389 has a backup of 0. Material number 101458264 as a backup of 0.

In one embodiment, the horizontal axis includes a customer inventory (“Cust Inv”) column that discloses the quantity of the corresponding material number that is in the customer's inventory. For example, material number 101023389 has a customer inventory of 0. Material number 101458264 has a customer inventory of zero.

In one embodiment, the scroll bar at the bottom of FIG. 5B allows additional portions of the material descriptions to be displayed.

In one embodiment, illustrated in FIG. 5C, the horizontal axis includes columns that disclose the excess and shortage of each material number by quarter. In one embodiment, the column headers are the quarters designated by the length in time from the current date. For example, the first column is labeled “3 Mo Supply/De,” which refers to supply versus demand for the next quarter (three months). For example, the second column is labeled “6 Mo Supply/De,” which refers to supply versus demand for the 3 month period beginning in 3 months. Similarly, the second column is labeled “6 Mo Supply/De,” which refers to supply versus demand for the 3 month period beginning in 6 months. The other columns have similar meanings. The scroll bar at the bottom of FIG. 5C allows the supply versus demand for additional orders to be displayed.

In one embodiment, illustrated in FIG. 5C, a grid appears below the supply/demand columns and to the right of the horizontal axis illustrated in FIG. 5B. The grid indicates the supply in on demand for each material number by quarter. For example, the demand for material number 101023389 (the top-most row in FIG. 5B) is 0 in all displayed quarters on FIG. 5C. The demand for material number 102056722 (the seventh row from the top in FIG. 5B) is 2 in the first quarter, 2 in the second quarter, 5 in the third quarter, 5 in the fourth quarter, 15 in the fifth quarter, and 15 in the sixth quarter.

In addition to the numerical information provided in the grid, the cells in the grid are color coded (represented by the crosshatching in the cells containing numbers) to indicate their procurement status. In one embodiment, the color coding is the same as that described above with respect to the forecast dashboard. In one embodiment, green shading (represented by the lower left to upper right crosshatching) indicates that the materials are in stock, yellow shading (none of the cells in FIG. 5C have this status) indicates that materials are on order but not in stock, and red shading (represented in FIG. 5C by the lower right to upper left crosshatching) indicates that materials are not in stock, are not on order and that the lead time for ordering parts is nine months.

### Material Planning Tab—Material Usage Flow Section

In one embodiment, the material usage flow section provides the material number information concerning what is required (e.g. quantity required, original total quantity, remaining total quantity, remaining stock, etc.).

In one embodiment, the material usage flow section includes a selection panel, illustrated in FIG. 6A. In one embodiment, a user can select the data to display on the material quantity requirements section using the selection panel. In one embodiment, the selection panel includes a “Current Selection” area that displays the current selection criteria. In one embodiment, the selection panel includes a “Rig—Well Status” area that allows selection of materials in stock, materials on purchase order, or materials unavailable. In one embodiment, the selection panel includes a “Material Availability” area that allows the selection of materials in stock, materials on purchase order, or materials unavailable. In one embodiment, the selection panel includes a “Rig” area that allows selection of one of the rigs included in the data (in the example shown, the rigs are Hercules 257, Honor, PN6, T XIV, and West Ven, with a scroll bar indicating that additional rigs are available for selection). In one embodiment, the selection panel includes a “Well” area that allows selection of one of the wells included in the data (in the example shown, the wells are BZ BP, NB BAF, BZ A-09, BZ B-09, and BZ BR, with scroll bar indicating that additional wells are available for selection). In one embodiment, the selection panel includes a “Well Date” area that allows selection of one of the displayed well dates (in the example shown, the well dates are Apr. 9, 2013, Nov. 24, 2013, Apr. 3, 2013, and Ap. 19, 2013, with a scroll bar indicating that additional well dates are available for selection). In one embodiment, the selection panel includes A “material number” area that allows selection of one of the displayed material numbers (in the example shown, the material numbers are 00000101083445, 00000000047018, 00000000056471, and 00000000071162 with a scroll bar indicating that additional material numbers are available for selection).

In the example shown in FIG. 6A, “materials in stock” and material number 00000101083445 have been selected, as indicated by the shading of these elements (represented by crosshatching) and in the “Current Selection” area of the selection panel.

In one embodiment, the selections illustrated in FIG. 6A and will produce the data shown in FIG. 6B. In one embodiment, the material number column displays the selected material number (material number 00000101083445 in the example shown). In one embodiment, the well date column shows the well date of the well where the selected material number is used (Nov. 24, 2013 in the example shown). In one embodiment, the well column shows the name of the well with the material number is used (BZ BP, in the example shown). In one embodiment, the rig column shows the name of the rig where the material number is used (PN6). In one embodiment, the quantity required column (“Qty Rqd”) shows the quantity of the material number required for the corresponding well on the corresponding well date (1 in the example shown). In one embodiment, the original quantity column (“Orig Qty”) shows the original quantity in stock (9 in the example shown). In one embodiment, the remaining quantity column (“Rem Qty”) shows the remaining quantity (9 in the example shown). In one embodiment, the remaining stock column (“Rem Stock”) shows the remaining quantity in stock (9 in the example shown). In one embodiment, the remaining quantity on order column (“Rem On Order”) shows the remaining quantity on order (0 in the example shown). In one embodiment, the stock available column (“Stock Avail”) shows the stock status using the symbols and colors described above for the status column of the forecast dashboard (see FIG. 2).

### Material Planning Tab—Quantity Required Section

In one embodiment, the quantity required section shows all material quantity is required for well. In one embodiment, a color coded availability column provides an indicator of what materials are in stock, etc.

In one embodiment, the quantity required section includes a selection panel, illustrated in FIG. 7A. In one embodiment, a user can select the data to display on the quantity required section using the selection panel. In one embodiment, the selection panel includes a “Current Selection” area that displays the current selection criteria. In one embodiment, the selection panel includes a “Rig—Well Status” area that allows selection of materials in stock, materials on purchase order, or materials unavailable. In one embodiment, the selection panel includes a “Material Availability” area that allows the selection of materials in stock, materials on purchase order, or materials unavailable. In one embodiment, the selection panel includes a “Rig” area that allows selection of one of the rigs included in the data (in the example shown, the rigs are Hercules 257, Honor, PN6, T XIV, and West Ven, with a scroll bar indicating that additional rigs are available for selection). In one embodiment, the selection panel includes a “Well” area that allows selection of one of the wells included in the data (in the example shown, the wells are BZ BP, NB BAF, BZ A-09, BZ B-09, and BZ BR, with scroll bar indicating that additional wells are available for selection). In one embodiment, the selection panel includes a “Well Date” area that allows selection of one of the displayed well dates (in the example shown, the well dates are Apr. 9, 2013, Nov. 24, 2013, Apr. 3, 2013, and Apr. 19, 2013, with a scroll bar indicating that additional well dates are available for selection). In one embodiment, the selection panel includes A “material number” area that allows selection of one of the displayed material numbers (in the example shown, the material numbers are 00000101083445, 00000000047018, 00000000056471, and 00000000071162 with a scroll bar indicating that additional material numbers are available for selection).

In the example shown in FIG. 7A, “materials in stock” and material number 00000101083445 have been selected, as indicated by the shading of these elements (represented by crosshatching) and in the “Current Selection” area of the selection panel.

In one embodiment, the selections illustrated in FIG. 7A produce the data shown in FIG. 7B. In one embodiment, the well column shows the name of the well with the material number is used (BZ BP, in the example shown). In one embodiment, the rig column shows the name of the rig where the material number is used (PN6). In one embodiment, the well date column shows the well date of the well where the selected material number is used (Nov. 24, 2013 in the example shown). In one embodiment, the availability column is colored coded using the color scheme described above and contains text describing the availability of the material number (“material in stock” in the example shown). In one embodiment, the material number column displays the selected material number (material number 00000101083445 in the example shown). In one embodiment, the material description column includes a description of the material number (“TBG NIP, 4½-12.75 CECO-A X 15.” in the example shown). In one embodiment, the quantity required column (“Qty Rqd”) shows the quantity of the material number required for the corresponding well on the corresponding well date (1 in the example shown).

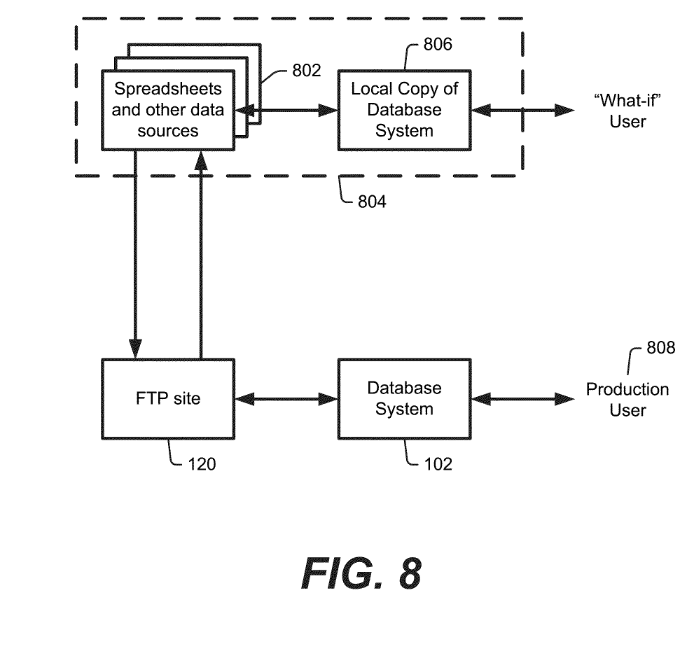

In one embodiment, illustrated in FIG. 8, data used to populate the screens illustrated in FIGS. 2, 3, 4A, 4B, 5A-5C, 6A-6C, 7A, and 7B is moved from the database system 102 to the FTP site 120 and is then downloaded to spreadsheets and other data sources 802 on a local computer 804 (i.e., a desktop, lap top, notebook, tablet, or cell phone). In one embodiment, a local copy of the database system 806, with at least a subset of the capabilities of the database system 102, imports the data from the spreadsheets and other data sources 802. In one embodiment, a “what-if” user experiments with the data using the local copy of the database system 806 by, for example, changing the well dates for selected wells, by changing the schematic for a given well, or by making some other change, and observes the impact on the inventory status. Once the “what-if” user arrives at a satisfactory well schedule, schematic assignment, etc., and receives approval through contractor and customer management, the local copy of the database system 806 loads the data into the spreadsheets and other data sources 802. The revised data is uploaded from the spreadsheets and other data to the FTP site 120. The database system then imports the data from the FTP site 120 and uses it to populate screens shown to production users 806.

The word “coupled” herein means a direct connection or an indirect connection.

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method comprising:
a processor accessing a list of projects;
the processor accessing a calendar comprising a start time when each of the projects is scheduled to begin;
the processor accessing a bill of materials for each of the projects, wherein the bill of materials for each project includes the materials required for that project, wherein some of the materials are common to more than one of the projects;
the processor accessing a material list comprising:
materials in stock and available for use in performing the projects,
materials on order and an estimated time when the materials on order will be available for use in performing the projects, and
materials not yet on order;
the processor allocating the materials among the projects according to the bill of materials for each project, wherein in allocating the materials the processor gives priority to the projects in order of their start times beginning with the start time nearest in time;
the processor displaying the list of projects including a material status for each project, wherein the material status is one of the following:
all materials necessary for the project are in stock,
not all materials necessary for the project are in stock, but those not in stock are on order, and
not all materials necessary for the project are in stock and at least of those materials not in stock are not on order.

2. The method of claim 1 wherein the material status “not all materials necessary for the project are in stock, but those not in stock are on order” comprises the following material statuses:
not all materials necessary for the project are in stock, but those not in stock are between manufacturing and goods receipt and are on order under a purchase order, and
not all materials necessary for the project are in stock, but those not in stock are between manufacturing and goods receipt and are not on order under a purchase order.

3. The method of claim 1 further comprising:
the processor displaying the list of projects to allow a revision to be entered;
the processor receiving a revision to the list of projects;
the processor reallocating the materials in light of the revision; and
the processor re-displaying the list of projects including the material status for each project in light of the revision.

4. The method of claim 3 wherein the revision comprises changing the start time for one of the projects so that the priority of the project changes relative to the priority of the other projects

5. The method of claim 1 further comprising:
a remote processor receiving the list of projects, the calendar, the bill of materials and the material list;
the remote processor receiving a revision to the list of projects;
the remote processor reallocating the materials in light of the revision; and
the remote processor forwarding the reallocated materials to the processor for approval.

6. The method of claim 1 further comprising:
the processor displaying for each of the projects the number of materials in stock, the number of materials not in stock but on order, and the number of materials not in stock and not on order.

7. The method of claim 1 further comprising:
the processor receiving an indication that a click has been made on a material status for a project and, in response, the processor displaying the identities and acquisition status of each of the materials that are not in stock for that project, wherein the acquisition status comprises an indication of whether the material is on order and a projected delivery date for the material.

8. The method of claim 1 further comprising:
the processor accessing location information for the materials and estimating the time to transport the materials to a location for each project.

9. A computer program stored in a non-transitory tangible computer readable storage medium, the program comprising executable instructions that cause a processor to:
access a list of projects;
access a calendar, wherein the calendar comprises a start time when each of the projects is scheduled to begin;
access a bill of materials for each of the projects, wherein the bill of materials for each project includes the materials required for that project, wherein some of the materials are common to more than one of the projects;
access a material list comprising:
materials in stock and available for use in performing the projects,
materials on order and an estimated time when the materials on order will be available for use in performing the projects, and
materials not yet on order;
allocate the materials among the projects according to the bill of materials for each project, wherein in allocating the materials the processor gives priority to the projects in order of their start times beginning with the start time nearest in time;
display the list of projects including a material status for each project, wherein the material status is one of the following:
all materials necessary for the project are in stock,
not all materials necessary for the project are in stock, but those not in stock are on order, and
not all materials necessary for the project are in stock and at least of those materials not in stock are not on order.

10. The computer program of claim 9 wherein the material status “not all materials necessary for the project are in stock, but those not in stock are on order” comprises the following material statuses:
not all materials necessary for the project are in stock, but those not in stock are between manufacturing and goods receipt and are on order under a purchase order, and
not all materials necessary for the project are in stock, but those not in stock are between manufacturing and goods receipt and are not on order under a purchase order.

11. The computer program of claim 9 further comprising executable instructions that cause the processor to:
display the list of projects to allow a revision to be entered;
receive a revision to the list of projects;
reallocate the materials in light of the revision; and
re-display the list of projects including the material status for each project in light of the revision.

12. The computer program of claim 11 wherein the revision comprises changing the start time for one of the projects so that the priority of the project changes relative to the priority of the other projects

13. The computer program of claim 9 further comprising executable instructions that cause the processor to:
transmit to a remote processor the list of projects, the calendar, the bill of materials and the material list;
receive from the remote processor reallocated materials based on a revision implemented by the remote processor;
display the reallocated materials for approval.

14. The computer program of claim 9 further comprising executable instructions that cause the processor to:
display for each of the projects the number of materials in stock, the number of materials not in stock but on order, and the number of materials not in stock and not on order.

15. The method of claim 9 further comprising executable instructions that cause the processor to:
receive an indication that a click has been made on a material status for a project and, in response, display the identities and acquisition status of each of the materials that are not in stock for that project, wherein the acquisition status comprises an indication of whether the material is on order and a projected delivery date for the material.

16. The method of claim 9 further comprising executable instructions that cause the processor to:
access location information for the materials and estimate the time to transport the materials to a location for each project.

17. A system comprising:
a database system having access to:
a list of projects;
a calendar comprising a start time when each of the projects is scheduled to begin;
a bill of materials for each of the projects, wherein the bill of materials for each project includes the materials required for that project, wherein some of the materials are common to more than one of the projects;
a material list comprising:
materials in stock and available for use in performing the projects,
materials on order and an estimated time when the materials on order will be available for use in performing the projects, and
materials not yet on order;
wherein the database system is programmed to allocating the materials among the projects according to the bill of materials for each project, wherein in allocating the materials the processor gives priority to the projects in order of their start times beginning with the start time nearest in time;
wherein the database system is programmed to display the list of projects including a material status for each project, wherein the material status is one of the following:
all materials necessary for the project are in stock,
not all materials necessary for the project are in stock, but those not in stock are on order, and
not all materials necessary for the project are in stock and at least of those materials not in stock are not on order.

18. The system of claim 17 wherein the database system is programmed to:
receive a revision to the list of projects;
reallocate the materials in light of the revision; and
re-display the list of projects including the material status for each project in light of the revision.

19. The system of claim 17 further comprising:
a remote processor with access to a copy of the list of projects, the calendar, the bill of materials and the material list;
wherein remote processor is programmed to:
receive a revision to the list of projects;
reallocate the materials in light of the revision; and
forward the reallocated materials to the database system for approval.
